(19) United States
(12) Patent Application Publication
(10) Pub. No.: US 2003/0059256 A1
(43) Pub. Date: Mar. 27, 2003

(54) Solid pavement marker

(76) Inventors: Thomas Gallup, Heath, OH (US); Peter Hedgewick, Windsor (CA)

Correspondence Address: Gifford, Krass, Groh, Sprinkle,, Anderson & Citkowski, P.C., Suite 400, 280 N. Old Woodward Avenue, Birmingham, MI, 48009, US

(21) Appl. No.: 09/965,614

(22) Filed: Sep. 27, 2001

(51) Int. Cl. G08B 1/00

(52) U.S. Cl. 404/16; 404/15; 404/72

(57) ABSTRACT

A solid reflective pavement marker includes a solid body having a base, a top wall parallel to the base, an end wall extending between the top wall and the base, and a side wall extending between the top wall and the base. The base, top wall, end wall and side wall are integral and formed as one solid piece from a thermoplastic material mixed with a gas liberating material. The solid reflective pavement marker also includes a reflective member fixedly attached to the end wall. The method of making a solid reflective marker includes the steps of melting a thermoplastic material by applying heat and mixing a gas liberating material with the thermoplastic material. The method also includes the steps of injecting the material mixture into a mold having a predetermined shape of a body of the reflective solid marker, wherein the body includes a base, a top wall parallel to the base, an end wall extending between the top wall and the base, and a side wall extending between the top wall and the base, the body having a bore extending partially therethrough from the base; and cooling the mold.

### BACKGROUND OF THE INVENTION

1. Field of the Invention

The present invention relates generally to reflective markers and, more specifically, to a solid reflective pavement marker for a roadway and a method of making the same.

2. Description of the Related Art

Reflective markers are frequently positioned on and along roadways to provide a driver of a vehicle with information regarding the road, especially when visibility is poor. For example, a reflective pavement marker is strategically positioned on the roadway to delineate a lane line. A reflective barrier marker is positioned on a barrier separating opposing lanes of traffic to indicate the location of the barrier.

The reflective marker is typically constructed as an assembly, with a shell-like housing having a cavity with an inner surface formed with cube corners for reflecting light from a source, such as a headlight of an oncoming vehicle. The inner surface of the cube corners includes a coating of a reflective material, such as aluminum. The cavity of the housing usually contains a filler material, such as a two-part urethane resin, to increase the structural strength of the housing assembly. An example of this type of reflective pavement marker is disclosed in commonly assigned U.S. Pat. No. 5,002,424 to Hedgewick, entitled “Reflective Pavement Marker With Inclined Reinforcing Ribs”; and U.S. Pat. No. 4,797,024 to Forrer, entitled “Abrasive Resistant Pavement Marker”, the disclosures of which are incorporated by reference. While these types of reflective pavement markers work well, they are manufactured using a multi-step process.

Another type of reflective pavement marker that is housingless, is disclosed in U.S. Pat. No. 5,927,897 to Attar, the disclosure of which is incorporated by reference. This reflective pavement marker includes a body made of a curable resinous material with inert additives for abrasion and impact resistance. While this type of reflective pavement marker also works well, it is expensive to manufacture due to the amount of raw material and the multi-step process. Thus, there is a need in the art for a cost-effective, solid reflective pavement marker, that is manufactured in a one-step process with a minimum amount of material.

### SUMMARY OF THE INVENTION

Accordingly, the present invention is a solid reflective pavement marker for a roadway. The solid reflective pavement marker includes a solid body having a base, a top wall parallel to the base, an end wall extending between the top wall and the base, and a side wall extending between the top wall and the base. The base, top wall, end wall and side wall are integral and formed as one solid piece from a thermoplastic material mixed with a gas liberating material. The solid reflective pavement marker also includes a reflective member fixedly attached to the end wall. The method of making a solid reflective marker includes the steps of melting a thermoplastic material by applying heat and mixing a gas liberating material with the thermoplastic material. The method also includes the steps of injecting the material mixture into a mold having a predetermined shape of a body of the reflective solid marker, wherein the body includes a base, a top wall parallel to the base, an end wall extending between the top wall and the base, and a side wall extending between the top wall and the base, the body having a bore extending partially therethrough from the base; and cooling the mold.

One advantage of the present invention is that a solid reflective pavement marker is provided that is made from a thermoplastic material with a foaming agent added during molding that releases air bubbles into the material to reduce material mass. Another advantage of the present invention is that a solid reflective pavement marker is provided that is lighter in weight. A further advantage of the present invention is that a method of manufacturing a solid reflective pavement marker is provided that is cost-effective.

Other features and advantages of the present invention will be readily appreciated, as the same becomes better understood after reading the subsequent description taken in conjunction with the accompanying drawings.

### BRIEF DESCRIPTION OF THE DRAWINGS

FIG. 1 is a perspective view of a reflective pavement marker positioned in relation to a roadway, according to the present invention.

FIG. 2 is an exploded view of the reflective pavement marker of FIG. 1, according to the present invention.

FIG. 3 is a section view of the body taken along line 3-3 of FIG. 1, according to the present invention.

FIG. 4 is a flowchart of a method of making a solid reflective pavement marker, according to the present invention.

### DESCRIPTION OF THE PREFERRED EMBODIMENT(S)

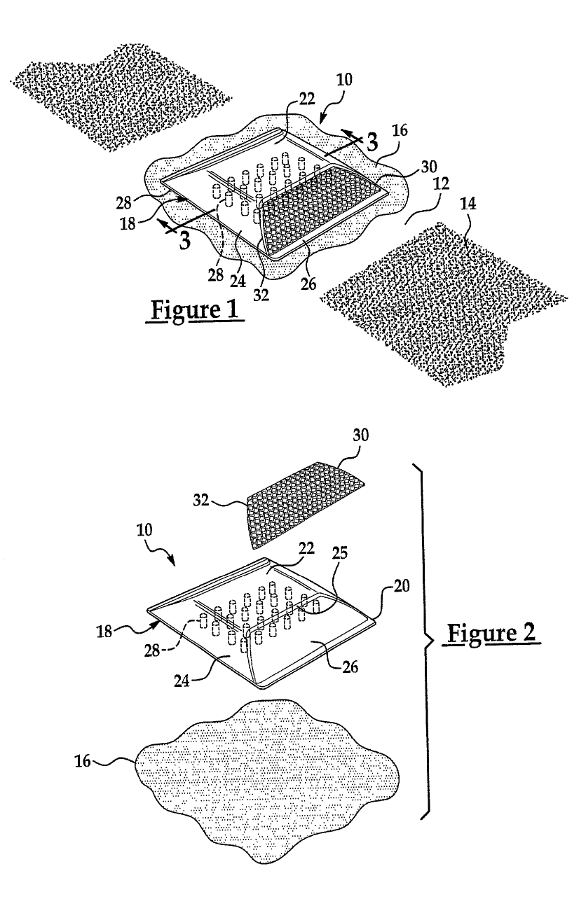

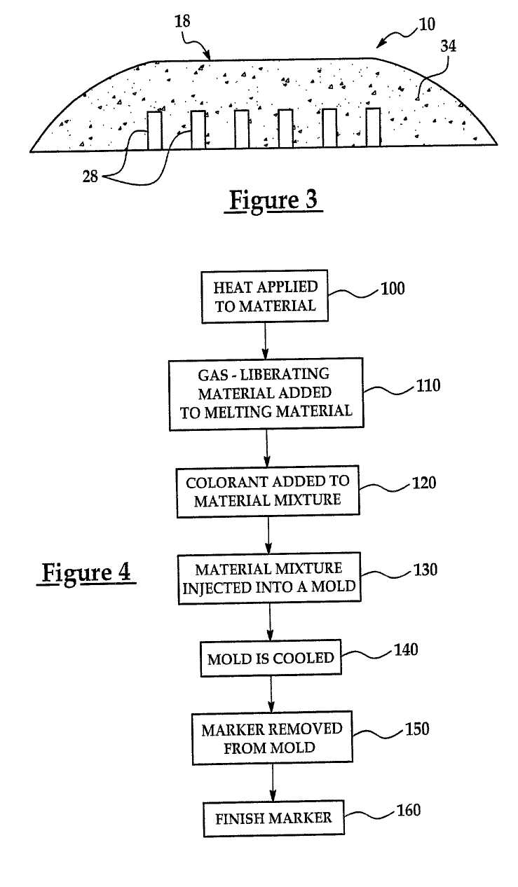

Referring to FIGS. 1 through 3, a solid reflective pavement marker 10 is illustrated in relationship to a roadway 12. Advantageously, the solid reflective pavement marker 10 is utilized to convey information to a driver of a vehicle (not shown), such as a boundary of a lane as delineated by a lane line 14. It should be appreciated that the solid reflective pavement marker 10 is adhesively secured to a surface, including the roadway 12 of this example, such as by using an epoxy material, as shown at 16.

The solid reflective pavement marker 10 includes a body 18 having a base 20, a top wall 22 parallel to the base 20, side walls 24 extending from an edge of the top wall 22 to an edge of the base 20, and an end wall 26 extending from another edge of the top wall 22 to a corresponding edge of the base 20 and extending transversely therebetween the side walls 24. It should be appreciated that the base 20, top wall 22, sidewalls 24 and end walls 26 are integral and formed as one piece having a solid body. The body 18 also includes a brow 25 or raised portion which is upwardly adjacent the edge of the top wall above the end wall.

The body 18 of the solid reflective pavement marker 10 is made from a wide variety of suitable materials that are impervious to high impacts and environmental conditions. An example of such a material is an impact resistant thermoplastic, such as a butyl styrene (ABS). It should be appreciated that a strength enhancing additive, such as a glass fiber, may be added to the body 18 material. A gas liberating material, such as a chemical foaming agent, is added to the material during molding. An example of a chemical foaming agent is EPIcor™ manufactured by Environmental Products Inc. The chemical foaming agent reacts with the application of heat to release a gas, which in this example are air bubbles shown at 34, that become trapped in the melting material. This process is referred to in the art as foaming. As the mold is cooled, the air bubbles 34 remain suspended in the material. As a result, the density of the body 18 is reduced and the amount of material required to mold the body 18 is reduced. It should be appreciated that although the presence of air bubbles 34 in the body 18 decreases the amount of material used in manufacturing the solid reflective pavement marker 10, the strength or durability of the reflective pavement marker 10 is not compromised.

The solid reflective pavement marker 10 also includes at least one bore 28 extending from the base 20 of the solid reflective pavement marker 10 into the body 18. In this example, the bore 28 has a cone shape, and a plurality of bores that are arranged in an array of rows and column. Advantageously, the bores 28 further reduce the amount of material required, and facilitates even cooling during molding.

The solid reflective pavement marker 10 includes a reflective lens 30 fixedly attached to an exterior surface of the end wall 26, such as by bonding. Preferably, the lens 30 is a cube-corner acrylic lens. The reflective lens 30 is joined to the end wall 26 using a known bonding process, such as sonic welding. The reflective lens 30 includes a plurality of cube-shaped members 32 arranged in a grid pattern and referred to in the art as a cube corner. Similar to a prism, a side of the cube-shaped member 32 forms an angle with a plane of the roadway 12, such that a light beam is reflected back to the eyes of the driver.

The reflective lens 30 may also include a reflective coating (not shown) that covers a back surface of the reflective lens 30, for protecting the reflectivity value of the reflective pavement marker 10. Preferably, the reflective coating is a reflective material, such as aluminum. In this example, the aluminum is bonded to the reflective lens 30 using a process known in the art as vacuum metalizing.

It should be appreciated that the reflective pavement marker 10 may include other component parts, such as housing structure base (not shown), which are conventional and known in the art for reflective pavement markers. The brow 25 protects the lens from excessive abrasion at its edge by lifting the tire of a vehicle slightly to provide a clearance space and prevent direct contact of the tire with the top edge of the lens.

Referring to FIG. 4, a flowchart of a process for manufacturing a solid reflective pavement marker 10 is illustrated. In a first step of the process, shown at block 100, heat is applied to a raw material, such as ABS, causing the material to melt. In a next step of the process shown at block 110, a gas liberating material, such as the chemical foaming agent, is added to the melting raw material. An example of a chemical foaming agent is EPIcor™, as previously described. The heat induces a chemical reaction in the material mixture, resulting in the liberation of a gas, such as air bubbles 34. The air bubbles 34 are trapped in the melting mixture, since the air bubbles 34 have a lower density than that of the melting material. In a next step of the process shown at block 120, a colorant may also be mixed in with the material mixture, so that the end product has a desired color, such as highway traffic safety yellow.

In a next step of the process shown at block 130, the homogeneous mixture of melted material is injected into a mold, preferably under pressure. It should be appreciated that these first steps of the process occur rapidly, and the timing is controlled by a controller, as is known in the art. For example, the raw material is fed into a chute, mixed with the foaming agent and the colorant using a rotatable auger, and heated. As the melted flow of material reaches a predetermined state, it is injected through a port into an interior cavity of the mold. As is understood in the art, the interior cavity of the mold has a predetermined shape, which yields the desired shape of the reflective pavement marker 10 after molding.

In a next step of the process shown at block 140, the material mixture in the mold is cooled, as is known in the art, so that the material mixture hardens into the desired shape of the solid reflective pavement marker 10. It should be appreciated that a surface of the mold may be configured to form the bore 28 extending into the body 18 of the solid reflective pavement marker 10, to facilitate cooling, as previously described.

In a next step of the process shown at block 150, the solid reflective pavement marker 10 is removed from the mold. In a last step of the process shown at block 160, the solid reflective pavement marker 10 is finished. For example, during finishing the reflective lens 30 is bonded to the end wall 26, such as by sonic welding, as previously described. It should be appreciated that the reflective lens 30 may include a reflective material coating, such as an aluminum plating, to protect its reflectivity.

Advantageously, the solid reflective pavement marker 10 produced using this process is more cost-effective to manufacture as compared to other types of reflective pavement markers. In addition, the solid reflective pavement marker 10 is lighter in weight as compared to other types of reflective pavement markers, resulting in decreased shipping costs.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

What is claimed is:

1. A solid reflective pavement marker comprising:
a solid body having a base, a top wall parallel to said base, an end wall extending between said top wall and said base, and a side wall extending between said top wall and said base;
wherein said base, top wall, end wall and side wall are integral and formed as one piece from a thermoplastic material mixed with a gas liberating material; and
a reflective member fixedly attached to said end wall.

2. A solid reflective pavement marker as set forth in claim 1 wherein said reflective member includes a plurality of integrally formed cube-shaped members arranged in a grid pattern.

3. A solid reflective pavement marker as set forth in claim 1 wherein said body has a bore extending from said base towards said top wall.

4. A solid reflective pavement marker as set forth in claim 1 wherein said gas liberating material is a chemical foaming agent.

5. A solid reflective pavement marker comprising:
a solid body having a base, a top wall parallel to said base, an end wall extending between said top wall and said base, and a side wall extending between said top wall and said base, said body having a bore extending partially therethrough said base;
wherein said base, top wall, end wall and side wall are integral and formed as one piece from a thermoplastic material mixed with a chemical foaming agent that releases air bubbles that are suspended in the material mixture; and
a reflective member disposed on said end wall, wherein said reflective member includes a plurality of integrally formed cube-shaped members arranged in a grid pattern.

6. A solid reflective pavement marker as set forth in claim 5 wherein said chemical foaming agent is baking soda.

7. A method of making a solid reflective pavement marker, said method including the steps of:
melting a thermoplastic material by applying heat;
mixing a gas liberating material with the thermoplastic material, wherein the heat causes the gas liberating material to release a gas that is trapped in the material mixture;
injecting the material mixture into a mold having a predetermined shape of a body of the reflective solid marker, wherein the body includes a base, a top wall parallel to the base, an end wall extending between the top wall and the base, and a side wall extending between the top wall and the base, the body having a bore extending partially therethrough from the base; and
cooling the mold.

8. A method as set forth in claim 7 including the step of removing the solid reflective marker from the mold after said step of cooling the mold.

9. A method as set forth in claim 7 including the step of bonding a reflective lens to the end wall.
